(19) United States
(12) Patent Application Publication
(10) Pub. No.: US 2026/0120618 A1
(43) Pub. Date: Apr. 30, 2026

(54) Method for display driver circuit for partial update

(71) Applicant: NOVATEK Microelectronics Corp., Hsin-Chu (TW)

(72) Inventor: Lung-Yu Chang Chien, Hsinchu City (TW)

(73) Assignee: NOVATEK Microelectronics Corp., Hsin-Chu (TW)

(21) Appl. No.: 19/344,542

(22) Filed: Sep. 30, 2025

Related U.S. Application Data
(60) Provisional application No. 63/704,038, filed on Oct. 7, 2024.

(51) Int. Cl. G09G 3/20

(52) U.S. Cl. CPC G09G 3/2096; G09G 2310/04; G09G 2310/08; G09G 2330/023; G09G 2340/0435; G09G 2370/10

(57) ABSTRACT

A method for a display driver circuit includes steps of: receiving an input frame having a plurality of slices from a host processor; detecting the earliest horizontal synchronization start packet in the plurality of slices, wherein the earliest horizontal synchronization start packet indicates a start of the earliest slice of a full refresh display area of an output frame; and updating the full refresh display area of the output frame in response to that the earliest horizontal synchronization start packet of the earliest slice of the full refresh display area is detected.

### CROSS REFERENCE TO RELATED APPLICATIONS

This application claims the benefit of U.S. Provisional Application No. 63/704,038, filed on Oct. 7, 2024. The content of the application is incorporated herein by reference.

### BACKGROUND OF THE INVENTION

### 1. Field of the Invention

The present invention relates to a method for a display driver circuit, and more particularly, to a method for a display driver circuit for realizing partial update of an image frame.

### 2. Description of the Prior Art

The Mobile Industry Processor Interface (MIPI) specification has introduced a video hybrid mode (VHM), which enjoys the benefits of the video mode and the command mode. In the VHM mode with the usage of an external horizontal synchronization signal sent from a host processor to a display driver integrated circuit (DDIC), a MIPI transmission interface between the host processor and the DDIC is allowed to return to a stop state LP11 during the time period where no image data is transmitted to the DDIC.

In this MIPI specification, a multi-frequency display (MFD) technique is further developed, which allows the DDIC to partially refresh an image frame when the image data of several areas need not to be refreshed. Under the application of the VHM mode with the MFD, the host processor can only send image data in one or more areas that need to be refreshed, and return to the LP11 state in the time periods without image data transmission. This approach requires that the host processor sends a 2Bh command to the DDIC for each image frame, where the 2Bh command indicates the positions of the areas to be refreshed in this image frame.

However, in some scenarios, the DDIC may require that the entire image frame needs to be fully refreshed, and send a full refresh request to the host processor accordingly. The host processor should modify the 2Bh command based on the request. In addition, the host processor should well control the timing of outputting the 2Bh command, allowing the DDIC to completely obtain the information of the areas that need to be refreshed carried in the 2Bh command before decoding the vertical synchronization start (VSS) packet; that is, the 2Bh command should be decoded and the related information should be completely obtained by the DDIC before the VSS packet of the corresponding image frame is received, to avoid the speed race problem that the DDIC decodes the 2Bh command after decoding the VSS packet. This increases the design burden of the host processor, especially when the 2Bh command is generated based on the full refresh request of the DDIC.

### SUMMARY OF THE INVENTION

It is therefore an objective of the present invention to provide a novel method for a display driver circuit, to obtain the information of partial refresh without the usage of the 2Bh command.

An embodiment of the present invention discloses a method for a display driver circuit. The method comprises steps of: receiving an input frame having a plurality of slices from a host processor; detecting the earliest horizontal synchronization start packet in the plurality of slices, wherein the earliest horizontal synchronization start packet indicates a start of the earliest slice of a full refresh display area of an output frame; and updating the full refresh display area of the output frame in response to that the earliest horizontal synchronization start packet of the earliest slice of the full refresh display area is detected.

Another embodiment of the present invention discloses a method for a display driver circuit. The method comprises steps of: receiving an input frame having a plurality of slices from a host processor; detecting a transmission start packet indicating a start of a full refresh display area of the input frame and a transmission end packet indicating an end of the full refresh display area of the input frame; and updating the full refresh display area of an output frame according to the transmission start packet and the transmission end packet.

Another embodiment of the present invention discloses a method for a display driver circuit. The method comprises steps of: receiving an input frame having a plurality of slices from a host processor; detecting the earliest valid data packet following a horizontal synchronization start packet in the plurality of slices; and updating a full refresh display area of an output frame in response to that the earliest valid data packet is detected.

Another embodiment of the present invention discloses a method for a display driver circuit. The method comprises steps of: receiving an input frame having a plurality of slices from a host processor; detecting an output signal sent from the host processor when receiving the input frame; and updating a full refresh display area of an output frame according to a level of the output signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a timing diagram of a display operation.

FIG. 2 is a timing diagram of a display operation when the MFD is applied.

FIG. 3 is a flowchart of an image transmission process according to an embodiment of the present invention.

FIG. 4 is a timing diagram of a display operation according to an embodiment of the present invention.

FIG. 5 is a flowchart of another image transmission process according to an embodiment of the present invention.

FIG. 6 is a timing diagram of a display operation according to an embodiment of the present invention.

FIG. 7 is a flowchart of another image transmission process according to an embodiment of the present invention.

FIG. 8 is a timing diagram of a display operation according to an embodiment of the present invention.

FIG. 9 is a timing diagram of another display operation according to an embodiment of the present invention.

FIG. 10 is a flowchart of another image transmission process according to an embodiment of the present invention.

FIG. 11 is a timing diagram of a display operation with a GPO pin according to an embodiment of the present invention.

FIG. 12 is a schematic diagram of a display system according to an embodiment of the present invention.

### DETAILED DESCRIPTION

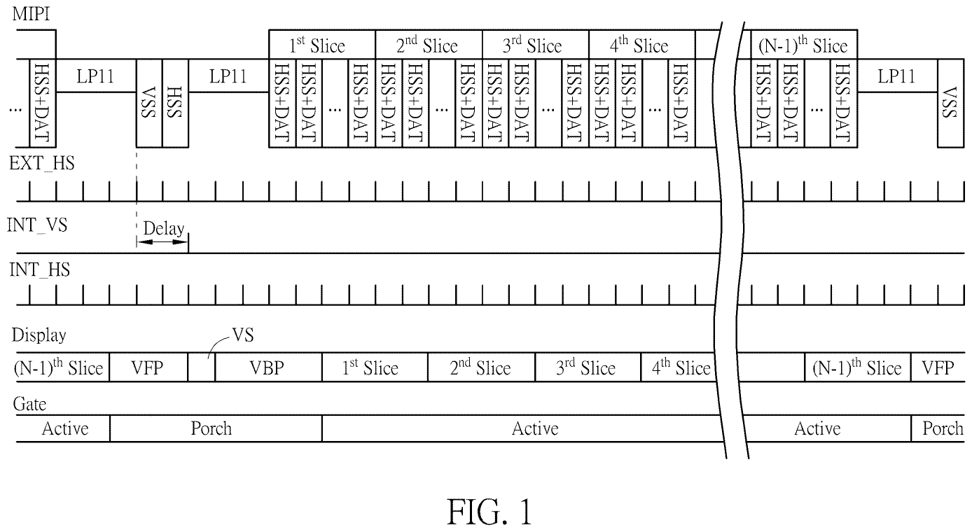

FIG. 1 is a timing diagram of a display operation, which illustrates the operations of a host processor sending a frame of image data with corresponding control signals to a display driver circuit (such as a display driver integrated circuit (DDIC)) through a transmission interface following Display Serial Interface (DSI) specification of Mobile Industry Processor Interface (MIPI) standard. More specifically, FIG. 1 shows the transmission state of the MIPI transmission interface between the host processor and the display driver circuit, an external horizontal synchronization signal EXT_HS received by the display driver circuit, an internal vertical synchronization signal INT_VS and an internal horizontal synchronization signal INT_HS used by the display driver circuit to control the display timing, and the display operation and corresponding gate control operation.

In detail, the host processor may transmit the image data by following the display stream compression (DSC) standard developed by the Video Electronics Standards Association (VESA). According to the DSC standard, a frame of image data may be divided into multiple slices for compression. Each slice may refer to the image data in a block or an area which is compressed and then transmitted; that is, a slice may be regarded as a minimum unit for compressing the image data, or may be regarded as a minimum unit for transmitting the image data. For example, as shown in FIG. 1, a frame of image data is divided into N slices, among which the 1^{st} slice to the (N−1)^{th} slice are transmitted sequentially. Each slice may include one or some horizontal synchronization start (HSS) packets, where each HSS packet indicates the start of a line of image data and is followed by the data packet DAT of the line data.

As shown in FIG. 1, in the beginning of the image frame, the host processor may transmit a vertical synchronization start (VSS) packet and an HSS packet, and then the MIPI transmission interface is controlled by the host processor to enter the LP11 state in the vertical back porch (VBP) interval. Subsequently, in the active period of image data transmission, the host processor transmits the 1^{st} to the (N−1)^{th} slices, with the HSS packets and data packets DAT in each slice. After the frame of image data is completely transmitted, the MIPI transmission interface enters the LP11 state in the vertical front porch (VFP) interval, until the start of the next frame period.

In order to well control the timing of image data transmission and reception, the host processor (or an external device) may transmit an external horizontal synchronization signal EXT_HS through a dedicated physical wire to the display driver circuit. In one or some embodiments, the host processor may send image data packets (via data lanes of the MIPI transmission interface) and also the external horizontal synchronization signal EXT_HS (via the physical wire) to the display driver circuit. In other embodiments, the host processor may enter a sleep mode for power saving when it does not need to send image data, and at this time, the display driver circuit may still receive the external horizontal synchronization signal EXT_HS from the host processor (or the external device) even though the display driver circuit no longer receives the HSS packets and data packets through the MIPI transmission interface. Based on the received VSS packet and the external horizontal synchronization signal EXT_HS, the display driver circuit may generate the internal vertical synchronization signal INT_VS and the internal horizontal synchronization signal INT_HS used for controlling the timing of outputting display data voltages to the display panel. As shown in FIG. 1, the internal vertical synchronization signal INT_VS may be generated with a delay (i.e., internal delay) from the received VSS packet. The display data voltages of the 1^{st} to the (N−1)^{th} slices are then output to the display panel according to the timing determined by the internal vertical synchronization signal INT_VS and the internal horizontal synchronization signal INT_HS. In addition, the gate control signals are active in the period where the display data voltages are output, to appropriately control the pixels on the display panel to receive the data voltages.

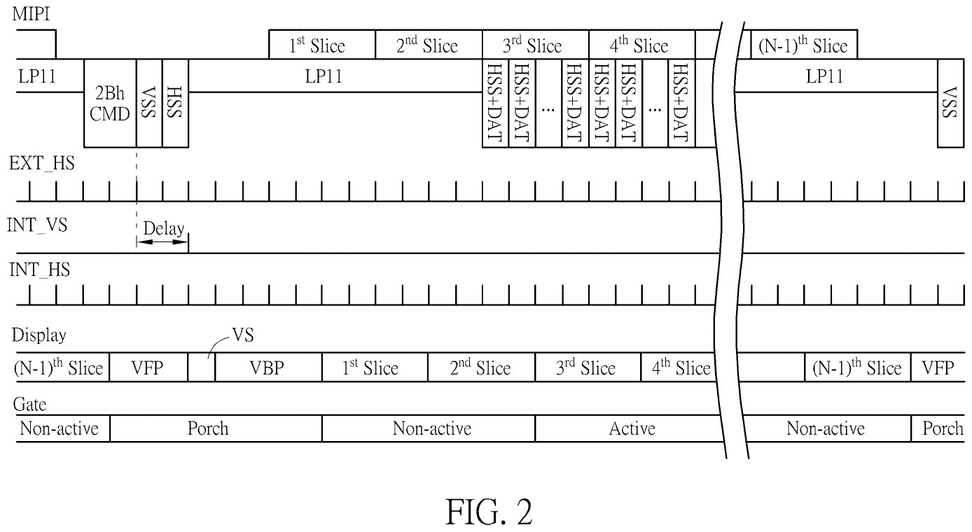

FIG. 2 is a timing diagram of a display operation when the multi-frequency display (MFD) is applied. Under the MFD operations, the host processor may transmit partial image data in an image frame. More specifically, an image frame with partial refresh may be divided into one or more full refresh display areas and one or more partial refresh display areas, where a full refresh display area refers to an area in which the image data is to be refreshed, and a partial refresh display area refers to an area in which the image data is not refreshed. In the video hybrid mode (VHM) of the MIPI transmission interface, the host processor may only transmit the image data in the full refresh display area, rather than transmit the image data of the entire image frame. The image data may still be transmitted in the predetermining timing as in the video mode.

For example, as shown in FIG. 2, the timing of the host processor outputting image data in a partial refresh image frame may be identical to the timing allocation as in the full refresh image frame shown in FIG. 1. As for the full refresh display area, the host processor may still transmit the image data to the display driver circuit in the predetermined time intervals (e.g., the 3^{rd} to the (N−3)^{th} slices). As for the partial refresh display area, the host processor may stop transmitting the image data to the display driver circuit in the predetermined time intervals (e.g., the 1^{st}, the 2^{nd}, the (N−2)^{th}, and the (N−1)^{th} slices). In the time intervals of the slices without image data transmission, the host processor may control the MIPI transmission interface to enter the LP11 state to save power.

Since the image frame is not fully refreshed, the host processor should provide information about the range of the full refresh display area and the range of the partial refresh display area. According to the MIPI specification, the host processor may send a 2Bh command before the VSS packet. The 2Bh command contains information indicating the start position of a full refresh display area and an end position of the full refresh display area. Based on the information, the display driver circuit may know when to start updating the image data (i.e., data voltages) and when to stop updating the image data (i.e., data voltages). In other words, the display driver circuit may obtain the boundaries or the range of the full refresh display area, and thereby transmit data voltages to refresh the pixels in this full refresh display area in the display panel, and stop transmitting data voltages for other area(s) (i.e., the partial refresh display area(s)). In addition, the display driver circuit may correspondingly control the gate circuit to be active in the time interval for refreshing the full refresh display area, and non-active in the time interval corresponding to the partial refresh display area.

Note that FIG. 2 only shows an exemplary implementation. In another example, there may be multiple full refresh display areas in an image frame; hence, the host processor may send multiple 2Bh commands to the display driver circuit, where each 2Bh command carries information of the start position and end position of one of these full refresh display areas. The 2Bh command(s) may be sent in the VFP before the VSS packet.

As mentioned above, the host processor should well control the timing of outputting the 2Bh command, in order to avoid the speed race problem that the display driver circuit decodes the 2Bh command after decoding the VSS packet. This increases the design burden of the host processor. In order to avoid this problem, the present invention provides a novel method for a display driver circuit, allowing the display driver circuit to obtain the information of full refresh display area(s) without the usage of the 2Bh command. In other words, the host processor does not need to send the 2Bh command to the display driver circuit, and the display driver circuit may determine the start position and/or the end position of the full refresh display area(s) by itself.

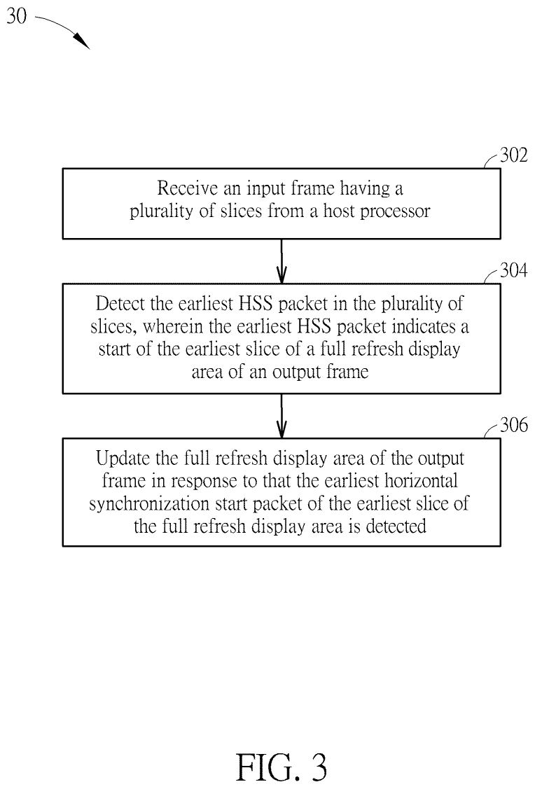

In one or some embodiments, the display driver circuit may determine the range of a full refresh display area by detecting the HSS packet in the slices. FIG. 3 is a flowchart of an image transmission process 30 according to an embodiment of the present invention. The image transmission process 30 may be implemented in a display driver circuit, such as a DDIC. As shown in FIG. 3, the image transmission process 30 includes the following steps:

Step 302: Receive an input frame having a plurality of slices from a host processor.

Step 304: Detect the earliest HSS packet in the plurality of slices, wherein the earliest HSS packet indicates a start of the earliest slice of a full refresh display area of an output frame.

Step 306: Update the full refresh display area of the output frame in response to that the earliest horizontal synchronization start packet of the earliest slice of the full refresh display area is detected.

According to the image transmission process 30, the display driver circuit may receive an input frame from the host processor (Step 302), where the input frame may include multiple slices and each slice may refer to a unit of transmitted image data. Among these slices, the display driver circuit may also detect the earliest HSS packet in a full refresh display area, in order to determine the start position of the full refresh display area in an output frame (Step 304), where the output frame is the frame of image data to be output to the display panel from the display driver circuit. Subsequently, the display driver circuit updates the image data in the full refresh display area in response to the earliest HSS packet being detected (Step 306).

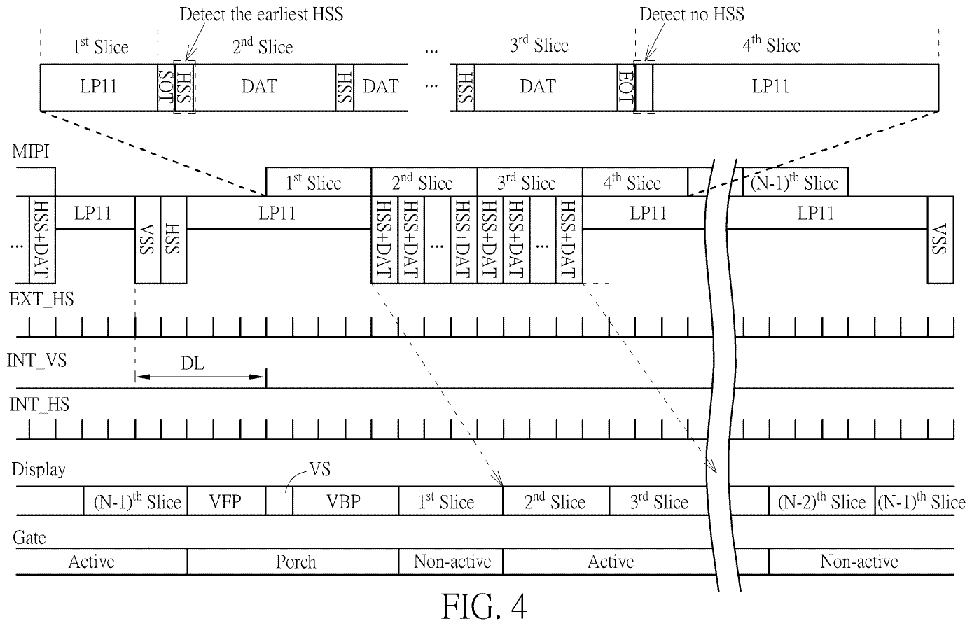

As mentioned above, a valid slice with image data transmitted by the host processor must include one or more HSS packets followed by the corresponding data packets DAT. For example, as shown in FIG. 4, if a slice is allocated to the full refresh display area, the host processor may transmit the data packets DAT of the slice (e.g., the 2^{nd} or the 3^{rd} slice), and the transmission of the slice may start with an HSS packet. On the other hand, if a slice is allocated to the partial refresh display area, the host processor may not transmit the image data of the slice (e.g., the 1^{st} or the 4^{th} slice), and thus in the time interval of this slice, there are no image data and no HSS packet transmitted by the host processor, and the MIPI transmission interface may enter the LP11 state.

In such a situation, the display driver circuit may determine whether the slice belongs to the full refresh display area or the partial refresh display area by detecting the HSS packet in the slice. In an embodiment, the display driver circuit detects the earliest HSS packet in the slices of the input frame to determine the start position of the full refresh display area, and updates/refreshes the data voltages in the full refresh display area accordingly. In the embodiment shown in FIG. 4, the display driver circuit may detect that the earliest HSS packet appears in the 2^{nd} slice, and thus start the update/refresh operation in the 2^{nd} slice of the output frame.

Subsequently, the display driver circuit may continuously detect the HSS packet, and then stop updating the data voltages when no HSS packet is detected in another slice. In other words, the first slice in which no HSS packet is detected may be considered as the start position of a partial refresh display area (which means the end of the previous full refresh display area). In the embodiment shown in FIG. 4, the display driver circuit may detect that no HSS packet is received in the 4^{th} slice, and thus stop the update/refresh operation in the 4^{th} slice of the output frame.

In the time interval corresponding to the partial refresh display area where no image refresh is performed, the display driver circuit may further detect the earliest HSS packet in subsequent slices, to determine the start position of the next full refresh display area. Accordingly, the display driver circuit may determine each slice in the image frame belongs to the partial refresh display area or the full refresh display area, so as to perform data refresh or not for each slice.

Since the display driver circuit determines the start position and/or the end position of the full refresh display area based on the detection result of the HSS packet, the display driver circuit may determine whether to perform the data update/refresh operation in the full refresh display area without considering a page address setting command (i.e., 2Bh command, which is 0x2B in a hexagonal form). In other words, the host processor does not need to send the page address setting command to the display driver circuit to provide the information of the full refresh display area, which means that there is no need to send the 2Bh command. At the display driver circuit side, it may identify the range of the full refresh display area by detecting the HSS packet, and perform the data update/refresh operation accordingly, regardless of whether the 2Bh command is received or not.

In addition, the display driver circuit may detect the HSS packets of the slices throughout the entire frame period, to determine the range or position of every full refresh display area in the image frame. In such a situation, the host processor does not need to provide multiple 2Bh commands if there are multiple full refresh display areas, and the display driver circuit may identify the range of all the full refresh display areas included in this image frame.

In order to allow the display driver circuit to have sufficient time to detect the HSS packet and determine whether the slice belongs to the full refresh display area, the internal vertical synchronization signal INT_VS should be provided with a delay time long enough from the external vertical synchronization signal (such as the received VSS packet shown in FIG. 4). In an exemplary embodiment, the delay time should be greater than or equal to a preconfigured time length of each slice; that is, the delay time should be greater than or equal to the slice size (e.g., slice height). For example, as shown in FIG. 4, the delay time DL is longer than the slice size. In such a situation, although the image data are received based on the timing defined by the external synchronization signal, the data voltages may be updated or refreshed at the timing defined by the internal vertical synchronization signal INT_VS, which has a sufficient delay time DL that allows the display driver circuit to identify whether each subsequent slice needs data update/refresh.

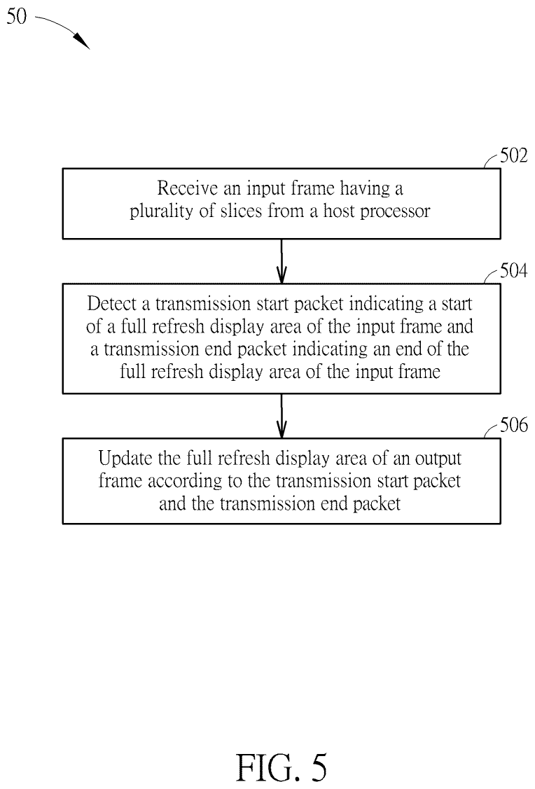

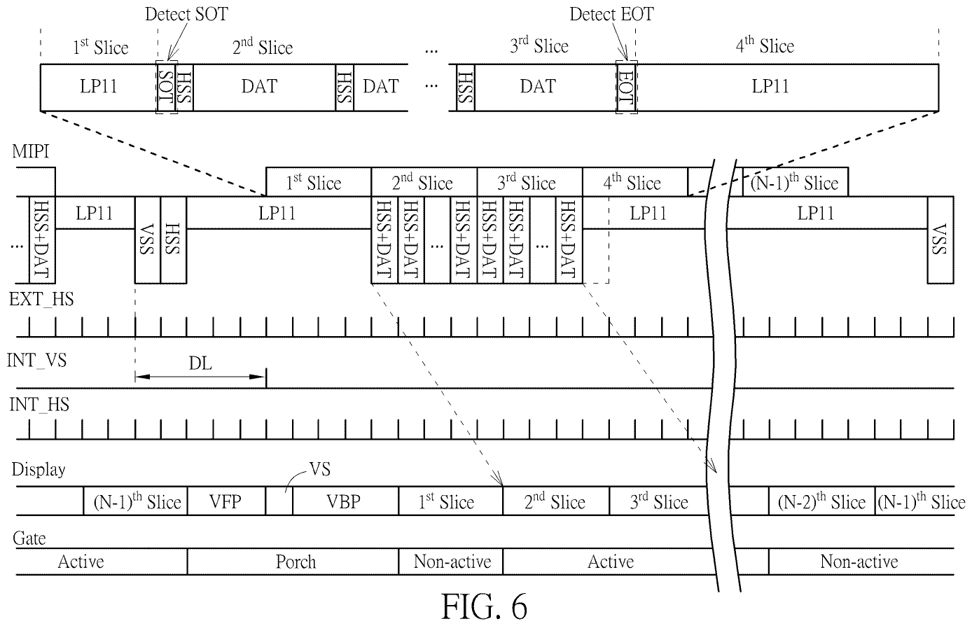

Note that the above operation of detecting the HSS packet is one of various embodiments of the present invention. In another embodiment, the display driver circuit may determine the range of the full refresh display area by detecting a transmission start packet (SOT packet in FIG. 6) and a transmission end packet (EOT packet in FIG. 6). FIG. 5 is a flowchart of another image transmission process 50 according to an embodiment of the present invention. The image transmission process 50 may be implemented in a display driver circuit, such as a DDIC. As shown in FIG. 5, the image transmission process 50 includes the following steps:

Step 502: Receive an input frame having a plurality of slices from a host processor.

Step 504: Detect a transmission start packet indicating a start of a full refresh display area of the input frame and a transmission end packet indicating an end of the full refresh display area of the input frame.

Step 506: Update the full refresh display area of an output frame according to the transmission start packet and the transmission end packet.

According to the image transmission process 50, the display driver circuit may receive an input frame from the host processor (Step 502), where the input frame may include multiple slices and each slice may refer to a unit of transmitted image data. The display driver circuit may also detect a transmission start packet and a transmission end packet, where the transmission start packet indicates the start of a full refresh display area, and the transmission end packet indicates the end of a full refresh display area (Step 504). Subsequently, the display driver circuit updates the image data in the full refresh display area according to the transmission start packet and the transmission end packet (Step 506). In other words, the display driver circuit starts updating a full refresh display area for displaying data (slices) which are received after the transmission start packet (SOT packet in FIG. 6) and keeps updating, until the transmission end packet (EOT packet in FIG. 6) is received.

Note that the image data on the MIPI transmission interface are transmitted in a high-speed mode, which is triggered by means of a start of transmission (SOT) procedure. In the SOT procedure, the host processor should send a SOT packet to start the high-speed transmission. Similarly, when the MIPI transmission interface needs to exit the high-speed mode, the host processor should send an end of transmission (EOT) packet.

In the embodiment shown in FIG. 6, the 1^{st} slice is allocated to the partial refresh display area, and then the 2^{nd} slice and the 3^{rd} slice are allocated to the full refresh display area. Therefore, the host processor sends a SOT packet at the start of the 2^{nd} slice to trigger the high-speed transmission for the data packets DAT. Subsequently, the image flow proceeds to the partial refresh display area in the 4^{th} slice. Therefore, the host processor sends an EOT packet at the end of the 3^{rd} slice, and then the MIPI transmission interface enters the LP11 state.

In such a situation, the display driver circuit may determine when the full refresh display area starts by detecting a transmission start packet such as the SOT packet, and may also determine when the full refresh display area ends by detecting a transmission end packet such as the EOT packet. The display driver circuit thereby updates/refreshes the image data in the full refresh display area according to the detection result of the SOT packet and the EOT packet.

Similarly, since the display driver circuit may determine the start position and/or the end position of the full refresh display area based on the SOT packet and/or the EOT packet, the display driver circuit may determine whether to perform the data update/refresh operation in the full refresh display area without considering a page address setting command, which means that the display driver circuit needs not to receive the 2Bh command from the host processor.

In addition, in order to allow the display driver circuit to have sufficient time to detect the SOT packet and the EOT packet and determine whether each slice belongs to the full refresh display area or the partial refresh display area, the internal vertical synchronization signal INT_VS should be provided with a delay time long enough from the external vertical synchronization signal. The delay time DL between the external vertical synchronization signal (e.g., received VSS) and the internal vertical synchronization signal INT_VS may be longer than or equal to the slice size, as shown in FIG. 6.

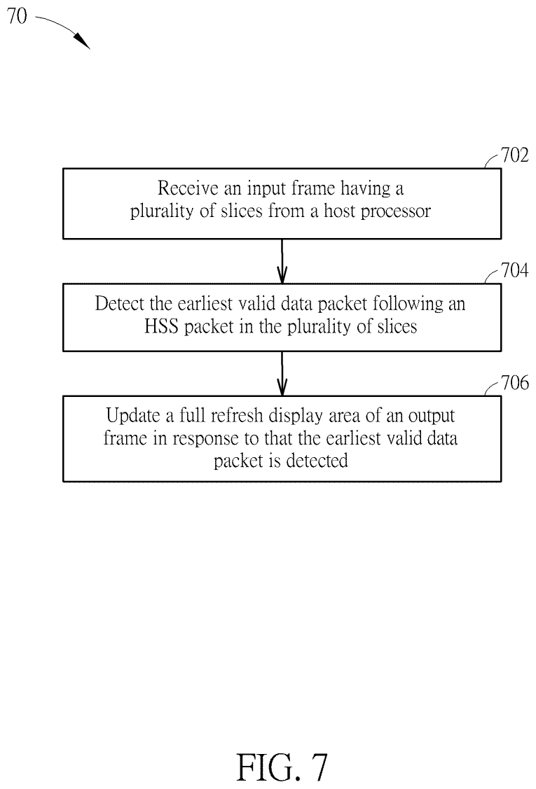

FIG. 7 is a flowchart of another image transmission process 70 according to an embodiment of the present invention. The image transmission process 70 may be implemented in a display driver circuit, such as a DDIC. As shown in FIG. 7, the image transmission process 70 includes the following steps:

Step 702: Receive an input frame having a plurality of slices from a host processor.

Step 704: Detect the earliest valid data packet following an HSS packet in the plurality of slices.

Step 706: Update a full refresh display area of an output frame in response to that the earliest valid data packet is detected.

According to the image transmission process 70, the display driver circuit may receive an input frame from the host processor (Step 702), where the input frame may include multiple slices and each slice may refer to a unit of transmitted image data. Among the slices, the display driver circuit may determine the start position of a full refresh display area by detecting the earliest valid data packet following the HSS packet in the full refresh display area (Step 704). Subsequently, the display driver circuit updates the image data in the full refresh display area in response to that the valid data packet is detected (Step 706).

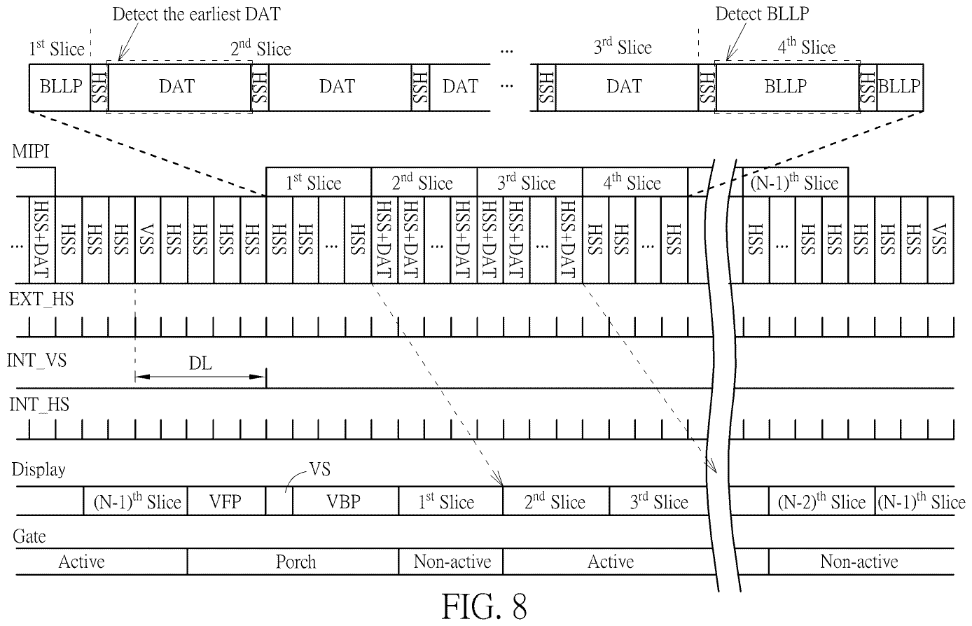

For example, in the time interval corresponding to the full refresh display area, the host processor may continuously transmit the HSS packet and the valid data packet DAT. Therefore, in addition to determining the start time of the full refresh display area by detecting the HSS packet, the display driver circuit may also determine the start time of the full refresh display area by detecting the valid data packet DAT. Taking the embodiment shown in FIG. 8 as an example, the display driver circuit may detect that the earliest valid data packet DAT appears in the 2^{nd} slice, and thus start the update/refresh operation in the 2^{nd} slice of the output frame.

In the embodiment shown in FIG. 8, the MIPI transmission interface may not enter the LP11 state when no image data is transmitted; instead, the host processor continuously sends the HSS packets with the predetermined timing. In the slice allocated to the full refresh display area, the HSS packet is followed by a valid data packet DAT; in the slice allocated to the partial refresh display area, the HSS packet is followed by a blanking or low-power (BLLP) interval where no valid data packet DAT is transmitted.

In such a situation, the display driver circuit may not be able to determine the start position of the full refresh display area by detecting the HSS packet since the HSS packet appears in both the full refresh display area and the partial refresh display area. The display driver circuit should detect the valid data packet DAT, and perform data update/refresh according to the detection result of the valid data packet DAT.

In a similar manner, the display driver circuit may detect the BLLP interval to determine the end position of the full refresh display area (which means the start position of the next partial refresh display area). In such a situation, the display driver circuit may stop updating the data voltages in the partial refresh display area when the BLLP interval is detected. In the embodiment shown in FIG. 8, the display driver circuit may detect that the BLLP interval appears in the 4^{th} slice, and thus stop the update/refresh operation in the 4^{th} slice of the output frame.

Similarly, since the display driver circuit may determine the start position and/or the end position of the full refresh display area based on the detection result of the valid data packet DAT and/or the BLLP interval, the display driver circuit may determine whether to perform the data update/refresh operation in the full refresh display area without considering a page address setting command, which means that the display driver circuit needs not to receive the 2Bh command from the host processor.

In addition, in order to allow the display driver circuit to have sufficient time to detect the valid data packet DAT and the BLLP interval and determine whether each slice belongs to the full refresh display area or the partial refresh display area, the internal vertical synchronization signal INT_VS should be provided with a delay time long enough from the external vertical synchronization signal. The delay time DL between the external vertical synchronization signal (e.g., received VSS) and the internal vertical synchronization signal INT_VS may be longer than or equal to the slice size, as shown in FIG. 8.

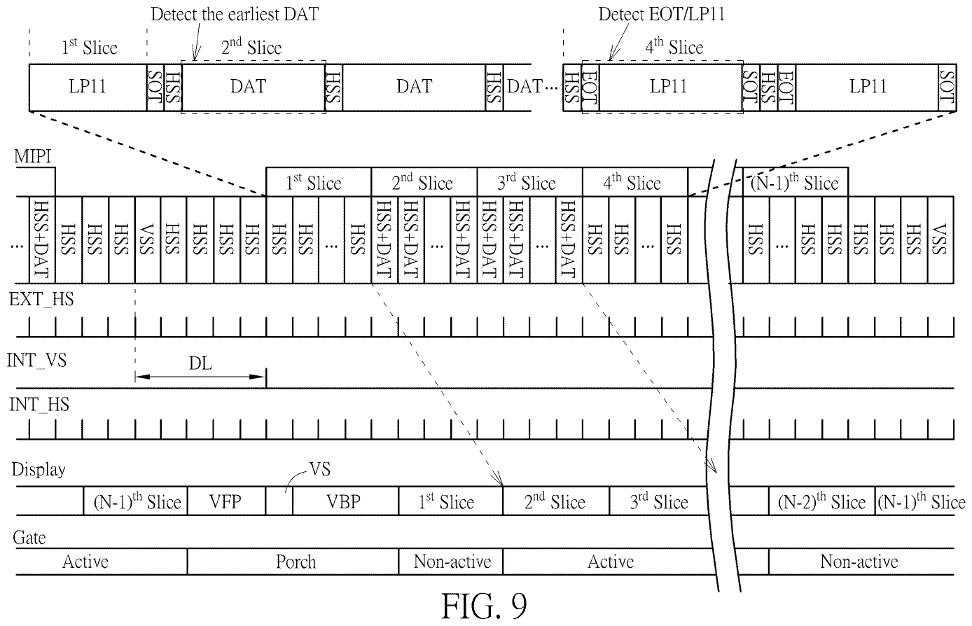

FIG. 9 is a timing diagram of another display operation according to an embodiment of the present invention. In this embodiment, the host processor still transmits the HSS packets in the time interval corresponding to the partial refresh display area, and the MIPI transmission interface enters the LP11 state to save power after the transmission of each HSS packet. In detail, the host processor sends the SOT packet to start the transmission of the HSS packet and sends the EOT packet to end the transmission of the HSS packet. In such a situation, the display driver circuit may determine the start position of the full refresh display area by detecting the valid data packet DAT, as similar to the operations shown in FIG. 8. In addition, the display driver circuit may determine the end position of the full refresh display area by detecting the EOT packet or detecting the state of the MIPI transmission interface. In other words, the display driver circuit may stop updating the data voltages in the output frame in response to the detection result that a slice has the EOT packet or that the MIPI transmission interface is in a stop state (such as LP11) in the time interval of a slice.

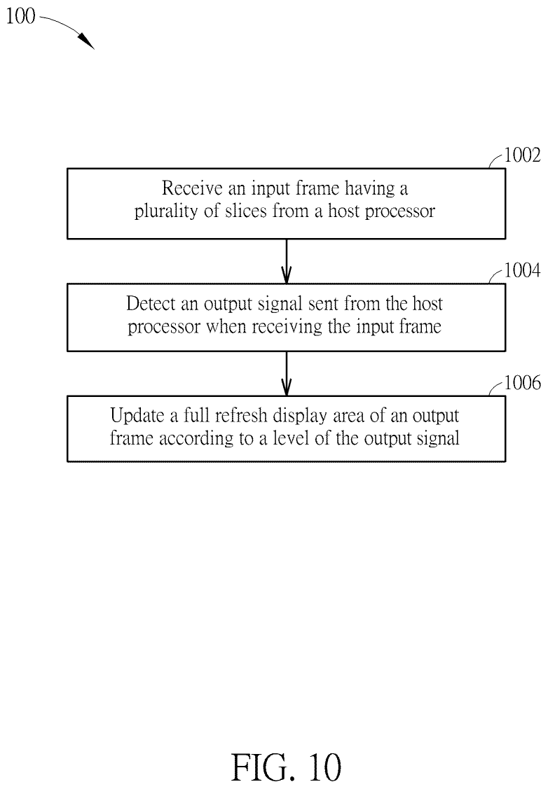

Note that in the above embodiments, the display driver circuit detects the behavior on the MIPI transmission interface to determine the start position, the end position, and/or the range of the full refresh display area, and performs the update/refresh operations accordingly. In another embodiment, the display driver circuit may determine the range of the full refresh display area by detecting another interface. FIG. 10 is a flowchart of another image transmission process 100 according to an embodiment of the present invention. The image transmission process 100 may be implemented in a display driver circuit, such as a DDIC. As shown in FIG. 10, the image transmission process 100 includes the following steps:

Step 1002: Receive an input frame having a plurality of slices from a host processor.

Step 1004: Detect an output signal sent from the host processor when receiving the input frame.

Step 1006: Update a full refresh display area of an output frame according to a level of the output signal.

According to the image transmission process 100, the display driver circuit may receive an input frame from the host processor (Step 1002), where the input frame may include multiple slices and each slice may refer to a unit of transmitted image data. The display driver circuit may determine the range of the full refresh display area by detecting an output signal sent from the host processor when receiving the input frame (Step 1004). Subsequently, the display driver circuit updates the image data in the full refresh display area according to the detection result of the output signal (Step 1006).

For example, in one or some embodiments, the display driver circuit may communicate with the host processor through a general purpose output (GPO) pin. In general, the host processor may send an output signal through the GPO pin, to notify the display driver circuit that the currently transmitted slice belongs to the full refresh display area or the partial refresh display area.

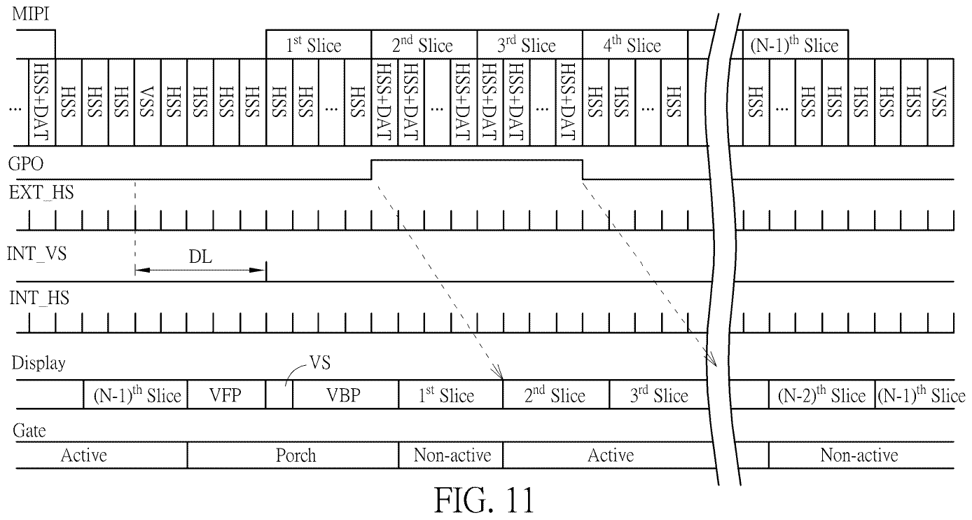

FIG. 11 is a timing diagram of a display operation with a GPO pin according to an embodiment of the present invention. In this embodiment, the host processor transmits a frame of image data to the display driver circuit through the MIPI transmission interface. When transmitting the image data, the host processor may further send an output signal to the display driver circuit through the GPO pin. As for the display driver circuit, the signal on the GPO pin may be regarded as a flag signal. The flag signal at a high level means that the currently transmitted slice belongs to the full refresh display area, and the flag signal at a low level means that the currently transmitted slice belongs to the partial refresh display area.

In such a situation, the display driver circuit may determine whether to perform the update/refresh operation according to the signal level on the GPO pin. In this embodiment, the display driver circuit may update the data voltages when detecting that the signal on the GPO pin is “High”, and may stop updating the data voltages when detecting that the signal on the GPO pin is “Low”. Therefore, the display driver circuit may appropriately determine whether each slice belongs to the full refresh display area or the partial refresh display area according to the signal on the GPO pin, thereby performs the update/refresh operation on the image data in the full refresh display area, while stops the update/refresh operation in the partial refresh display area.

Similarly, since the display driver circuit may determine the range of the full refresh display area based on the detection of the GPO pin, the display driver circuit may determine whether to perform the data update/refresh operation in the full refresh display area without considering a page address setting command, which means that the display driver circuit needs not to receive the 2Bh command from the host processor.

In addition, in order to allow the display driver circuit to have sufficient time to detect the signal level on the GPO pin and determine whether each slice belongs to the full refresh display area or the partial refresh display area, the internal vertical synchronization signal INT_VS should be provided with a delay time long enough from the external vertical synchronization signal. The delay time DL between the external vertical synchronization signal (e.g., received VSS) and the internal vertical synchronization signal INT_VS may be longer than or equal to the slice size, as shown in FIG. 11.

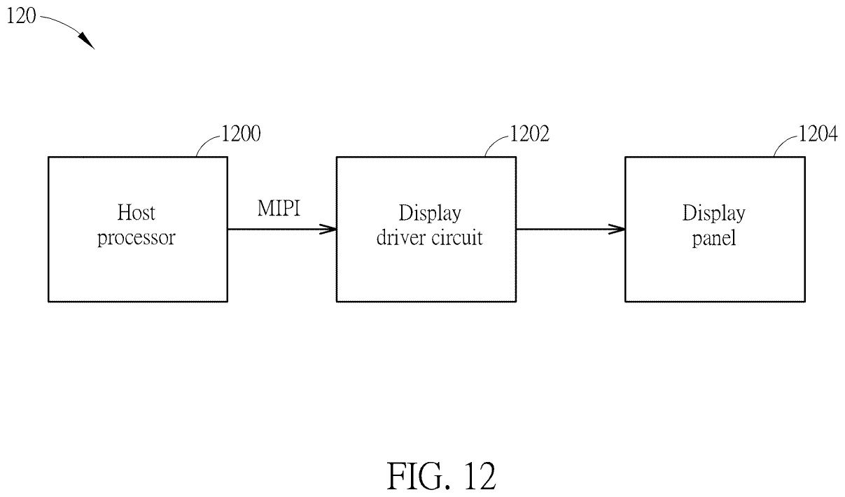

FIG. 12 is a schematic diagram of a display system 120 according to an embodiment of the present invention. The display system 120 includes a host processor 1200, a display driver circuit 1202 and a display panel 1204. The host processor 1200 may be a core processor of the display system 120, such as a central processing unit (CPU), an application processor (AP), a microcontroller unit (MCU), a microprocessor, or the like. As for a smart phone or wearable device, the host processor 1200 may be an AP configured to control various applications and operations of the smart phone or wearable device. The display driver circuit 1202 may be an IC (i.e., DDIC) used for controlling the display operations of the display panel 1204. In one or some embodiments, the display driver circuit 1202 may receive image data from the host processor 1200 through the MIPI transmission interface. The display panel 1204 may be any type of display device, which includes, but not limited to, a liquid crystal display (LCD) panel, light-emitting diode (LED) panel, and organic LED (OLED) panel.

Note that the present invention aims at providing a novel method for a display driver circuit, to obtain the information of partial refresh without the usage of the 2Bh command. Those skilled in the art may make modifications and alterations accordingly. For example, in the above embodiments, the display system may be operated in the video mode or the video hybrid mode of the MIPI transmission interface with the MFD operation, where the host processor transmits partial image data in an image frame by following the timing defined by synchronization signals. Note that the applications of the present invention are not limited thereto. For example, the image data received by the display driver circuit from the host processor may be directly forwarded to the display panel or may be written into a memory. In addition, the host processor may send image data based on the MFD scheme or not. In fact, as long as the display driver circuit may determine the start position and/or the end position of the full refresh display area by itself without considering the 2Bh command or any other page address setting command, it may belong to the scope of the present invention.

In addition, according to the embodiments of the present invention, the host processor is allowed to not send the 2Bh command since the display driver circuit may determine the range of the full refresh display area by itself. In one or some embodiments, the host processor may stop sending the 2Bh command and any other similar page address setting command. Alternatively, the host processor may still send the 2Bh command through the MIPI transmission interface or any other interface, and the display driver circuit may ignore or discard this command.

Also note that in this disclosure, the term “full refresh display area” represents a refresh display area which is refreshed whenever the full refresh image frame or the partial refresh image frame comes, and the term “partial refresh display area” represents a non-refresh display area in the partial refresh image frame. In general, based on the MFD operations, the image frames may be refreshed in various manners. Among a series of image frames, there may be several full refresh image frames in which all areas are refreshed, and may be several partial refresh image frames in which only some areas are refreshed. Therefore, in order to differentiate these areas, a full refresh display area is an area refreshed in all image frames, including the full refresh image frames and the partial refresh image frames, while a partial refresh display area is an area refreshed in the full refresh image frames but not refreshed in the partial refresh image frames. In such a situation, as for a partial refresh image frame, the full refresh display area is an area where data refresh is performed, and the partial refresh display area is an area where data refresh is not performed. Those skilled in the art would know that the full refresh display area may also be referred to as an “active area” or “refresh area”, and the partial refresh display area may also be referred to as a “non-active area” or “non-refresh area”.

To sum up, the present invention provides a method for the display driver circuit to obtain the information of the range of the full refresh display area in an image frame without considering or receiving the 2Bh command provided by the host processor. Based on the MFD operation, the full refresh display area refers to an area in which data refresh is performed, and the partial refresh display area refers to an area in which data refresh is not performed. In an embodiment, the display driver circuit may determine the start position of the full refresh display area by detecting the earliest HSS packet. In an embodiment, the display driver circuit may determine the start position and the end position of the full refresh display area by detecting the SOT packet and the EOT packet, respectively. In an embodiment, the display driver circuit may determine the start position of the full refresh display area by detecting the earliest valid data packet following an HSS packet, while determine the end position of the full refresh display area by detecting the BLLP interval or the EOT packet or the LP11 state. In an embodiment, the display driver circuit may determine the range of the full refresh display area by detecting the signal level on a GPO pin. As a result, the display driver circuit may determine to perform the data update/refresh operations in the full refresh display area, while stop the data update/refresh operations in the partial refresh display area, and the host processor needs not to provide the 2Bh command for the display driver circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a display driver circuit, comprising:
receiving an input frame having a plurality of slices from a host processor;
detecting the earliest horizontal synchronization start packet in the plurality of slices, wherein the earliest horizontal synchronization start packet indicates a start of the earliest slice of a full refresh display area of an output frame; and
updating the full refresh display area of the output frame in response to that the earliest horizontal synchronization start packet of the earliest slice of the full refresh display area is detected.

2. The method of claim 1, wherein the step of updating the full refresh display area of the output frame comprises:
determining when to update the full refresh display area of the output frame without considering whether a page address setting command is received or not.

3. The method of claim 1, further comprising:
receiving an external vertical synchronization signal; and
generating an internal vertical synchronization signal by delaying the external vertical synchronization signal with a delay time,
wherein the full refresh display area of the output frame is updated at a timing defined by the internal vertical synchronization signal, and
wherein the delay time is greater than or equal to a preconfigured time length of each of the plurality of slices.

4. The method of claim 1, further comprising:
stopping updating a partial refresh display area of the output frame when no horizontal synchronization start packet is detected in another slice of the partial refresh display area.

5. A method for a display driver circuit, comprising:
receiving an input frame having a plurality of slices from a host processor;
detecting a transmission start packet indicating a start of a full refresh display area of the input frame and a transmission end packet indicating an end of the full refresh display area of the input frame; and
updating the full refresh display area of an output frame according to the transmission start packet and the transmission end packet.

6. The method of claim 5, wherein the step of updating the full refresh display area of the output frame comprises:
determining when to update the full refresh display area of the output frame without considering whether a page address setting command is received or not.

7. The method of claim 5, further comprising:
receiving an external vertical synchronization signal; and
generating an internal vertical synchronization signal by delaying the external vertical synchronization signal with a delay time,
wherein the full refresh display area of the output frame is updated at a timing defined by the internal vertical synchronization signal, and
wherein the delay time is greater than or equal to a preconfigured time length of each of the plurality of slices.

8. The method of claim 5, wherein when the full refresh display area starts is determined by the transmission start packet, and when the full refresh display area ends is determined by the transmission end packet.

9. A method for a display driver circuit, comprising:
receiving an input frame having a plurality of slices from a host processor;
detecting the earliest valid data packet following a horizontal synchronization start packet in the plurality of slices; and
updating a full refresh display area of an output frame in response to that the earliest valid data packet is detected.

10. The method of claim 9, wherein the step of updating the full refresh display area of the output frame comprises:
determining when to update the full refresh display area of the output frame without considering whether a page address setting command is received or not.

11. The method of claim 9, further comprising:
receiving an external vertical synchronization signal; and
generating an internal vertical synchronization signal by delaying the external vertical synchronization signal with a delay time,
wherein the full refresh display area of the output frame is updated at a timing defined by the internal vertical synchronization signal, and
wherein the delay time is greater than or equal to a preconfigured time length of each of the plurality of slices.

12. The method of claim 9, further comprising:
stopping updating a partial refresh display area of the output frame in response to that a slice having a blanking or low-power (BLLP) interval among the plurality of slices is detected.

13. The method of claim 9, further comprising:
stopping updating a partial refresh display area of the output frame in response to that a slice having a transmission end packet or a stop state among the plurality of slices is detected.

14. A method for a display driver circuit, comprising:
receiving an input frame having a plurality of slices from a host processor;
detecting an output signal sent from the host processor when receiving the input frame; and
updating a full refresh display area of an output frame according to a level of the output signal.

15. The method of claim 14, wherein the step of updating the full refresh display area of the output frame comprises:
determining when to update the full refresh display area of the output frame without considering whether a page address setting command is received or not.

16. The method of claim 14, further comprising:
receiving an external vertical synchronization signal; and
generating an internal vertical synchronization signal by delaying the external vertical synchronization signal with a delay time,
wherein the full refresh display area of the output frame is updated at a timing defined by the internal vertical synchronization signal, and
wherein the delay time is greater than or equal to a preconfigured time length of each of the plurality of slices.

17. The method of claim 14, further comprising:
stopping updating a partial refresh display area of the output frame when the output signal is in a second level different from the first level.

18. The method of claim 14, wherein the output signal is received through a general purpose output (GPO) pin of the display driver circuit.
